(19) United States
(12) Patent Application Publication
(10) Pub. No.: US 2015/0382058 A1
(43) Pub. Date: Dec. 31, 2015

(54) Rakestraw advertising, marketing, and promotions business model

(71) Applicant: Christopher Rakestraw Humes, West Orange, NJ (US)

(72) Inventor: Christopher Rakestraw Humes, West Orange, NJ (US)

(21) Appl. No.: 14/318,694

(22) Filed: Jun. 30, 2014

(51) Int. Cl. H04N 21/442; H04N 21/81; H04N 21/258; H04N 7/16; H04N 21/2543

(52) U.S. Cl. CPC H04N 21/44218; H04N 7/165; H04N 21/2543; H04N 21/25435; H04N 21/25866; H04N 21/812

(57) ABSTRACT

A method for creating discounts. In using this method with commercials, (10) participants watch the required commercials independent of programming content to qualify for discounts. Participants can also watch any other required content for their discount. It also lays out the steps necessary in preparation to offer discounts. This embodiment includes an additional method to make sure applicable ads and content are watched in their entirety without the use of an honor system. (9) It also offers reprieve to participants who fall short of what is required to receive applicable discounts. This method also (6) utilizes other forms of advertising, marketing, and promotion besides TV commercials to create various discounts.

### BACKGROUND

1. Field

This application generally relates to communications, specifically is in the area of media, communications, and advertising.

2. Prior Art

The following is prior art that presently appears relevant:

U.S. Pat.

| Pat. No. | Kind Code | Issue Date | Patentee |
|---|---|---|---|
| 6,057,872 | B1 | 2000 May 2 | Candelore |

TV services like cable TV and Satellite TV are very expensive for the average person. It becomes even more expensive when combined with high-speed internet and pay TV phone service.

Before cable and satellite TV, there was broadcast TV which was free as long as your television could pick up the broadcast signal. The broadcasters would cover their cost by airing commercial advertisements along with their programs. This was the traditional TV business model at the time.

When cable and satellite TV came along, they offered excellent reception and more TV network choices for viewers. The business model then shifted to a subscriber business model where subscribers pay a monthly fee for the array of choices and clear picture. This was combined with traditional broadcast advertising and has become the dominant business model for television.

As time went on over the years, computer technology accelerated. The internet came into play, threatening the cable and satellite TV business model. Web TV is what they call it. Many of these web TV options offer much of the same programming ala carte as the traditional networks. Some of them even offer it live and for free. Many have limited commercials and some have none at all.

This begs the question, why would anyone pay for cable or satellite TV when they can get free or cheap content on the web? That is, free, cheap and ala carte at the viewer's convenience when cable and satellite TV is so expensive.

It's a similar situation with newspapers and magazines. Why should anyone bother purchasing either when they can get the same information on the web faster and with more up to date information? And for free.

Technology had a similar effect on the music industry business model as well. Traditional brick and mortar music stores have virtually all shut down. Now people get their music from Apple Incorporated's ITUNES and other similar services on the internet. Sometimes for free.

All of these business models have been affected by technology and the web. Many newspapers and magazines have gone completely under. Satellite and cable TV companies are experiencing what has been termed by the industry as cord cutting, meaning subscribers are canceling their cable and satellite TV subscriptions; getting their news and entertainment from web TV options instead.

The television business model is broken. This has made it difficult to turn a profit.

In a patent search for similar inventions, U.S. Pat. No. 6,057,872 (2000) to Candelore; Brant came up.

It has a method in which people must watch commercials separate from programming to receive a discount or free service. However, it lacks accountability. That being, a method to make sure commercial advertisements were actually watched.

Candelore's method depends heavily on the honor system. Even if electronically they could tell someone activated certain commercials, they can't actually prove the person watched the entire reel of ads. That person could have actually hit the play button, walk out the room, come back 10 minutes later and claimed they watched all the required commercials. There is no way to back it up except by an honor system. If you are an advertiser, this poses a problem.

Also, the method in Candelore's U.S. Pat. No. 6,057,872 (2000) does not spell out the steps for creating a viable discount. It simply requires users to buy a certain amount of Pay-Per-View programming or watch some commercials as a requirement to get a discount on pay TV. It is not that simple.

Candelore's U.S. Pat. No. 6,057,872 (2000) focuses particularly on discounts for Pay-Per-View services. After ordering a certain amount of Pay-Per-View service they receive a free or discounted additional Pay-Per-View program.

In addition, Candelore's U.S. Pat. No. 6,057,872 (2000) does not offer reprieve for those who participate to earn their discount and fall short of what is required. Because of that, it would be hard to convince participants to return and try again.

For example, if participants are required to watch 100 commercials a month and they only watched 85, they would not qualify for their cable TV discount using Candelore's U.S. Pat. No. 6,057,872 (2000). The participant is left feeling discouraged and will be reluctant to participate again.

The following are disadvantages of prior art:

(a) A method of just watching required commercials to get a discount alone lacks the accountability of the viewer's claims to actually have watched those required commercials.

(b) To create a viable discount there are other factors that must be considered like the cost of commercial, how many commercials, the length of commercials, the likely number of actual participants, and the likely number of non participants who are subscribers.

(c) No reprieve is offered if participants fall short of watching the required commercials. For example, if participants have to watch 250 commercials in one billing period, and watched only 225, they would not qualify for their discount. They would be left discouraged and reluctant to participate again.

(d) Does little or nothing to cut the high price of pay TV; especially cable TV.

### SUMMARY

In accordance with one embodiment it comprises of a method for creating custom discounts where participants must watch advertisements independently of programming content. In addition, participants take part in other applicable marketing and promotional experiences doing the same. It is supported by an additional method for making sure the commercials are actually watched. It also offers reprieve for those who fall short of all the requirements. All of the above in this summary, work toward achieving particular discounts.

### DRAWINGS

### Figures

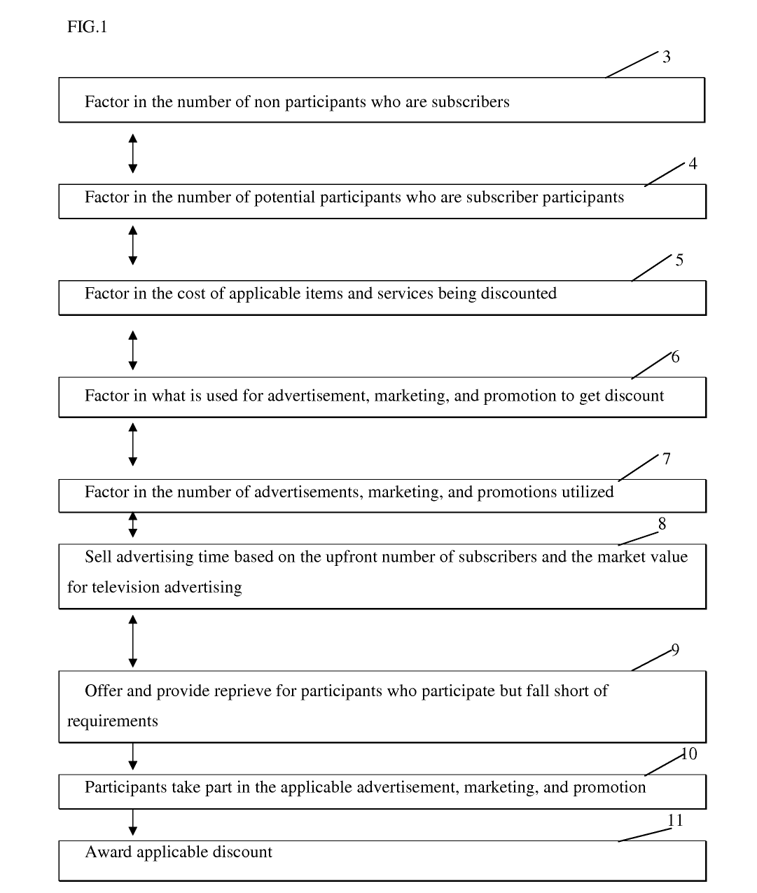

FIG. 1 shows a method flowchart for creating and awarding custom discounts using a multimedia device.

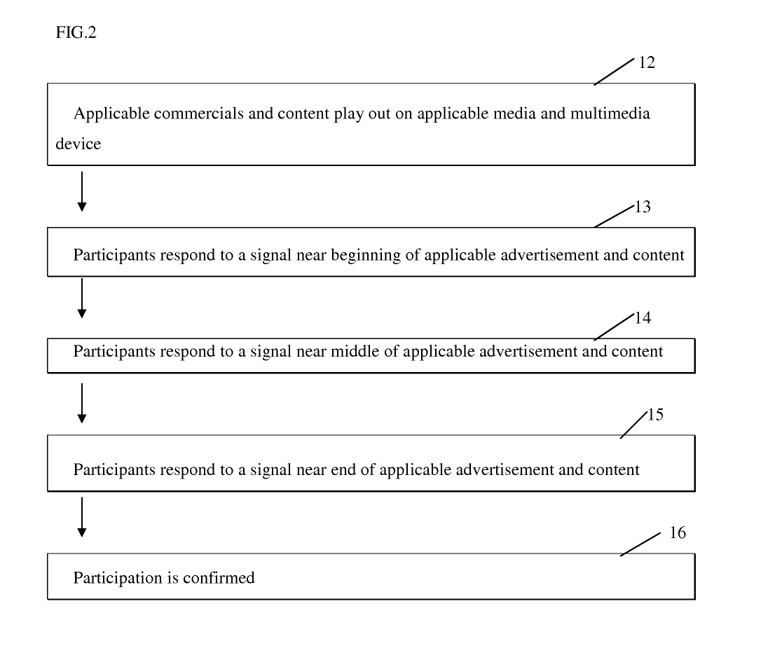

FIG. 2 shows a method flowchart for making sure participants actually watched applicable advertisements and content to receive their discount using a multimedia device.

### DETAILED DESCRIPTION

### FIGS. 1 and 2—First Embodiment

One embodiment of this method for creating free or discounted items and services, particularly for cable, satellite, web TV or similar services is by applying the steps is in FIG. 1 along with FIG. 2 as it applies.

FIG. 1 is a method flowchart for creating and awarding custom discounts using a multimedia device. The steps that follow may vary in order except steps 10 and 11. A multimedia device is used for computations, media play-out, and participation.

FIG. 1 step 3 states, “Factor in the number of non participants who are subscribers”. This is necessary in order to counterbalance any financial shortcomings in achieving discounts and rewards.

Mathematically, the discounts may come up short when considering what can be reasonably charged for a commercial. That is, if everyone who can participate, participates. Many will not. This is where FIG. 1 step 3 comes in. Just because a discount is being offered does not mean everyone will take advantage of it. Those who don't take advantage of it loose their discount and it ends up in a so called pool.

This unclaimed or so called pooled number of funds then gets rewarded to those who did participate. In other words, if it is a $100 cable TV bill with a half off or a $50 discount offer for watching a certain amount of commercials independent of content, not every subscriber will participate for whatever reason. They might be to lazy, can already easily afford their service, or they don't have time to participate and so on.

Those who did not participate would lose their lets say what would amount in hard math to a $10 discount with 24 million subscribers after watching 16 commercials a day. That is for an entire month. That leaves $90 dollars worth of unpaid discounts for each participating subscriber. Basically, the participating subscriber only got $10 off of their bill hard math. Not the half off their cable bill that was promised.

Commercial advertisements were sold based on the number of subscribers referred to in FIG. 1 step 8, not the number of actual participants. So there remains a certain amount of $10 discounts in limbo. Those $10 discounts in limbo end up going to subscribers who did participate. Thus, the discount is covered. So, that $10 discount becomes a $50 discount for the person who did participate. Hence, half off the cable bill.

In FIG. 1 step 4 it states, “Factor in the number of potential participants who are subscriber participants”. For example, it would be the number of subscribers the cable company already has in addition to any added potential subscribers. This will help determine the level of discount that can be offered.

The more or less participants there are the more or less advertisement, marketing, and promotion must be sold. Otherwise, the cable or satellite company would have to forgo higher profit to honor the original discount. Also, it takes into account that not every participant, while participating is considered a subscriber.

FIG. 1 step 5 states, “Factor in the cost of applicable items and services being discounted”. The cost of the item or service must be factored in determining how much of a discount can be honored. If the item or service is only $5 for example and there are 12 million subscriber participants, it would be much easier to offer the item or service for free. That is compared to if there were 12 million subscribers and the item or service cost $150 each. This difference effects whether something can be reasonably discounted or awarded free. It also effects whether the particular company can turn a profit using an applicable model.

If there are only 3 million participant subscribers and the item or service cost $100, it would be a challenge without participants making a sizable contribution. Remember, you can only charge the advertiser based on the base number of subscribers. If the subscriber base is low and the cost of the item or service is high, you got a problem. If you are lucky, the factor in FIG. 1 step 3 will come into play. Meaning, not all of the subscribers who are eligible will participate will participate.

In FIG. 1 step 6 it states, “Factor in what is used for advertisement, marketing, and promotion to get discount”. In other words what must be viewed, and or used, and or experienced to get the applicable free item, service, or discount.

In most cases, your basic TV commercials will be watched in doing what is required to get the discount or free service. Basically, a participant watches a certain number of regular commercials independent of programming to get their pay TV discount.

However, there are other options like participants being required to visit certain websites, watching certain TV shows, going to certain movies, even going to certain stores and restaurants to get their discount. Any type of advertising, marketing, and or promotion works.

FIG. 1 step 6 must also be factored in because the business model shifts slightly in that the amounts business' charge may change. For example, a theatre owner may have to charge a dollar for a new release to the subscriber and at the same time pay the cable or satellite TV provider a marketing fee.

I call this type of shift, a sub model. In this situation, movie attendance was sold as ad marketing time to the cable or pay TV company as if it were a commercial. Participants get to go see a recently released movie that's on its way out for let's say a dollar. They do so knowing they are also working toward a discount on their cable bill or applicable fee. This is one example of why FIG. 1 step 6 must be factored in.

Another example would be where all participating subscribers would have to tune into the QVC cable network at a certain time as part of getting their discount. Or, watch an infomercial independently of a network, perhaps on web TV or On Demand. They might even have to tune into a radio station at certain time, building toward their discount.

All of the different advertising, marketing, and promotions must be factored in because what and how they are charged will vary. Also, how it is viewed or experienced will vary also.

FIG. 1 step 7 states, “Factor in the number of advertisements, marketing, and promotions utilized”.

This is necessary because if the number and cost of the advertisements, marketing, and promotion are at odds with what can reasonably be asked of participants to do, either it won't work or the cable provider will lose a lot of money. Everything must be balanced.

In other words, you can't ask participants to watch 200 ads a day and expect anyone to reasonably do so. What is charged for the certain number advertisements and must jive with the reasonable number of expectations and requirements for the reward. Likewise, you can't expect participants to go to 10 restaurants a day for a month. It's not reasonable and must be reconsidered.

FIG. 1 step 8 states, “Sell advertising time based on the upfront number of subscribers and the market value for television advertising”.

The number of subscribers is basically the number of potential viewers. That is a number advertisers and cable or satellite TV providers can both use to determine how much to charge for advertising spots.

It is the same principle with participants who are not necessarily subscribers. Those who are registered as a participant are counted as a subscriber but are not actually a true subscriber. They may not be a subscriber to that particular pay TV service, but can still participate. They can do so even without their currant pay TV provider's permission.

The above number is then converted to a potential viewer number which is in turn sold as advertising time like it is for TV.

FIG. 1 step 9 states, “Offer and provide reprieve for participants who participate but fall short of requirements”.

Imagine if you are a participant and you did everything that was required for only 85 percent of the commercials and activities out of a 1 month billing cycle and you lost your discount. Basically, you fell short after a strong effort. All that commercial watching and required activities for nothing . . . You probably would be angry and never participate again.

FIG. 1 step 9 simply makes an offer to reprieve. It also actually gives that reprieve to a subscriber participant when applicable. In other words, participants might not get the big discount or free item if they fall short, but they will get awarded something special for trying.

For example, instead of receiving a full discount or free cable, the participant might earn a free weekend of HBO. Or they might receive some cool merchandise. That's just for trying. This keeps participants from getting discouraged. At the same time it encourages participants to try again next time.

FIG. 1 step 10 states, “Participants take part in the applicable advertisement, marketing, and promotion”. This is when the participant actually does what is required for the discount.

It could be going to a museum and or watching a certain amount of commercials. It could be watching a season premier of a new TV show or visiting a job web site. It can even be buying a certain candy bar for a promotion. Basically, it can be any type of advertising, marketing, and promotion. Which ever applies can be determined by the entity making they offer. Regional and local ads can be used to spread the cost per advertising spot.

FIG. 1 step 11 states, “Award applicable discount”. This is when the applicable discount is awarded after the participant has met the applicable requirements.

In FIG. 1 steps 3, 4, 5, 6, 7, 8 and 9 may vary in order.

FIG. 1 lays out the method for creating and awarding discounts, free items, and services. Part of FIG. 1 step 10 is when participants actually watch ads mostly independent of programming content.

If you went up to someone and asked them to watch some stand alone commercials for nothing, the will likely refuse. If you tell them they will get a significant discount if they do, they are more likely to do so. If you are not there to make sure they actually sat there and watched the commercials, they might turn the ads on but end up doing something else in another room yet claim they did watch the ads. Some will some won't.

FIG. 2 is a method for addressing the fact that participants need to be held accountable for advertisements they have claimed to have watch, avoiding a flawed honor system.

FIG. 2 is a method flowchart for making sure participants actually watched applicable advertisements and content to receive their discount using a multimedia device.

To avoid the reliance on an honor system for watching the required advertisements, the method in FIG. 2 must be applied to the method in FIG. 1. This method in FIG. 2 is very important. If it is not used in conjunction with the method in FIG. 1, advertisers cannot with confidence pay out their money simply believing the ads were watched. The participants could claim to have watched all kinds of advertisements and content but did not. There has to be accountability. The method in FIG. 2 provides that, completing the over all business model.

FIG. 2 step 12 states, “Applicable commercials and content play out on applicable media and multimedia device”. Obviously participants have to observe the content. To observe it, it has to play out on a particular device. FIG. 2 step 12 addresses it.

FIG. 2 step 13 states, “Participants respond to a signal near beginning of applicable advertisement and content”. To catch the beginning signal, the participant's attention must remain on the screen. When they see it, they respond using a multimedia device.

FIG. 2 step 14 states, “Participants respond to a signal near middle of applicable advertisement and content”. To catch the middle signal, the participant's attention must remain on screen. When they see it, they respond using a multimedia device.

FIG. 2 step 15 states, “Participants respond to a signal near end of applicable advertisement and content”. To catch the signal near the end, the participant's attention must remain on screen. When they see it, they respond using a multimedia device. Attention is kept start to finish using FIG. 2, step 13, 14, and 15.

FIG. 2 steps 13, 14 and 15 are where a participant signals that they are watching the screen. For the sake of example, during a 30 second commercial, a little white dot would appear on the screen near the beginning, middle and end. When the viewer sees the signals, they respond by pressing their device or touch screen confirming they saw it. That's how participants register their viewership. In order to catch the signals, they must constantly be watching the screen throughout the applicable commercials and media content. That is, from beginning to end.

FIG. 2 step 16, states, “Participation is confirmed”. At this point, participants and advertisers can confirm that the applicable commercials and content were watched. Both advertiser and participant can now prove participants watched the required advertisements and content in their entirety without use of honor system. Now participants can claim their discount and advertisers and content producers will know with confidence the material was actually watched.

At this point, participants have qualified for their applicable discount and free items and service. That is, short of any other requirements. For example, if part of the requirement includes the participant visiting a certain restaurant or trying a new product.

Both the method in FIG. 1 and the method in FIG. 2 work together. FIG. 1 alone relies too much on an honor system for watching the required advertisements and content. When combined with the method in FIG. 2, a working method is created although they each can operate independently.

Participants have now qualified for their applicable discount, free items, and service. That is short of any other requirements. For example, if part of the requirement included the participant visiting a certain furniture store or trying a new product. If this is the case, they may have more to do to qualify.

Anything can be used for the advertisements, marketing, and or promotion. A traditional commercial can be used. It can also be a promotion like watching a full TV show as the designated commercial. It could be participating in a marketing event in place of the commercial viewing. It could be visiting a physical location as the promotion or even visiting a virtual location as marketing. This is another aspect of FIG. 1 step 6. Each designated company is charged as if it were a commercial.

Also, on air promos, digital billboards, and sponsored public service announcements can replace traditional commercials for a fee. Tuning into a radio program at a certain time by all participating subscribers can also be used as marketing and promotions . . . All of these varying in use and time to get discounted or free cable, satellite TV and other items and services. The cost per advertisement, marketing venture, and or promotion may vary depending market variables.

### Operation—First Embodiment—FIGS. 1 AND 2

Using the pay TV provider Comcast Corporation, as an example, the operation of the method flowchart FIG. 1 is used to create and award viable discounts for cable TV or even free service. This is just one example of a use of the methods in FIG. 1 and FIG. 2.

FIG. 1 step 3 states, “Factor in the number of non participants who are subscribers”. In this step, take into account that not everyone who can participate actually will participate.

It takes into account laziness, peoples' ability to pay, internet access, and so on. If everyone who could participate participated, Comcast wouldn't break even. It is understood, with this step, that it is very unlikely that everyone will participate and must be taken into account.

FIG. 1 step 3, although not obvious it is very important. In order to make up the difference in honoring the discount or free cable TV, it has to be factored in. The people who do not participate actually lose their discount to those that did. If not, in the case of Comcast, there would be little or no profit if they paid out to every last subscriber. That is, if everyone actually participated.

Mathematically, if Comcast were to offer a ½ off the average $75 dollar cable bills, and participants only had to watch 16 commercials a day at $500k each for a month, it would only add up to a $10 discount per participant. On average you would need about $38. That is per participant.

Whoever received a $10 reward, also receives several $10 rewards from non-participants who forfeited their participation. Those extra $10 discounts bring the original $10 discount to a $40 dollar discount. Thus they receive half off the cable bill while Comcast maintains profit levels.

FIG. 1 step 4 states, “Factor in the number of potential participants who are subscriber participants”. In this case with Comcast Corporation, it has around 24 million base subscribers. This number may increase if they recruit additional participants.

FIG. 1 step 5 states, “Factor in the cost of applicable items and services being discounted”. For this Comcast Corporation example, meaning cable TV, it would be about $75 dollars a month for average cable TV subscriber fee at the time of this application.

FIG. 1 step 6, “Factor in what is used for advertisement, marketing, and promotion to get discount”.

Using traditional TV commercials, Comcast Corporation would have to require that participants watch at least 16 commercials a day to honor the half off cable discount. That is with ⅕ participation by their 24 million subscribers. Comcast Corporation would have charged advertisers the going rate for TV advertising at the time of this application. That is about $500k for each commercial in this case, raising approximately $240 million per month. Regional and local ads can be used to spread the cost per advertising spot.

Depending on the ad market, it may or may not be difficult to sell $500k national ad spots. The solution would be to sell regional and local ads along with the national spots.

For example, if there are five regions in the United States, a $500k spot could be divided into five regions. Each regional ad buyer would pay $100k for and ad spot instead of $500k. The cumulative effect of all the regions combined is a $500k commercial spot filled. This is one of the 16 minimum national ads needed to honor the half off discounts for participants using Comcast Corporation and it's variables as an example. The number of ads to be sold goes up. However the number of ads each participant would have to watch to get their discount remains the same. The same concept applies to local ads when dividing up regional ads.

A traditional TV commercial is not always the only advertisement, marketing, and promotion used. There are many options and additions. Sometimes it is an infomercial. That means Comcast can charge a higher rate. It might be a promotion where subscribers would have to visit a website as part of their requirement for their discount or free service. Subscribers might have to join a gym for seven days for free as marketing for that gym, to get their discount or free service. There are times when subscribers may have to pay a $1 out of pocket to go to a newly released movie that is part of a promotion for their pay TV discount.

For this Comcast Corporation example, let's say they must tune into a TV show premiere. In this marketing promotion, Comcast would charge the TV shows producers perhaps, $8 million dollars.

Generally, there is enough room in a 30 minute show for 16, 30 minute commercials. Remember, Comcast has some 24 million subscribers. That is potentially 24 million subscribers watching 16, 30 second commercials at $500,000 dollars each. So Comcast can charge about $8 million dollars for the half hour show.

The TV premiere gets its marketing, Comcast gets $8 million dollars and subscribers are one step closer to their discount. As a bonus, there are commercials built into the TV show. This makes it even more viable.

If this is applied four times a month, that's $384 million dollars per year for Comcast Corporation. Keeping in mind that it doesn't necessarily have to be a TV premiere but can be a show that needs a ratings boost.

FIG. 1 step 6 also applies to visiting web sites. In this case participants are be required to visit a web site as marketing as promotion. Comcast Corporation would provide some 24 million visitors more or less to a particular webs site. The 24 million are from their number of subscribers for which they will charge the going rate for TV commercial advertising. At the time of this application, it would be around $500k per combined 24 million Comcast Corporation subscriber visit. The subscribers are that much closer to their cable discount and Comcast Corporation picks up additional profit. If this is used twice a day at $500k each, it would raise $365 million dollars a year for Comcast Corporation using this model.

Also in this case, the participants and subscribers would have tune into an hour of the cable network QVC all at the same time. That is up to 24 million viewers for the QVC network for one hour instead of watching just traditional commercials as a requirement.

On the QVC network they actually sell products at discounts as their airtime. They don't use traditional commercials. The more viewers they have, the more product they can potentially sell. The QVC network would simply pay Comcast Corporation $8 million dollars per half hour airtime. That is roughly the going rate for TV advertising at the time of this application, with Comcast Corporation's roughly 24 million subscribers participating. If this is done four times a month for a half hour, it will raise about $384 million dollars a year for Comcast Corporation using this model.

FIG. 1 step 6 also applies to infomercials. Just like viewers would tune into the QVC Network for an hour, participants would have to watch infomercials as part of the requirement for their cable discount. At the going TV advertising rate, Comcast Corporation would simply charge the infomercial producers $8 million dollars per half hour infomercial. Comcast Corporation then provides their roughly 24 million subscribers. If this is done four times a month for a year it would raise $384 million dollars applying this applications method.

FIG. 1 step 6 also applies to movie going. Comcast Corporations roughly 24 million subscribers would agree to see a recently released movie for about $1. The movie studio would pay Comcast Corporation an advance of $8 million dollars for it as a marketing tool.

Because there can be multiple participants per subscriber household, it increases the number moviegoers dramatically. With an average of about 3 participants per 24 million households, that is potentially 72 million movie tickets sold for $1 each. Using this model once per month for 12 months, Comcast Corporation would raise an additional $864 million dollars a year. Participants are one step closer to their cable TV discount.

All together, Comcast Corporation would need around $240 million dollars a month to honor a half off discount for the participants. That having ⅕^{th} participation overall, remembering FIG. 1 step 3. It was achieved using the 16 TV commercials a day scenario alone.

The other scenarios become profit. That is, $32 million a month using the required TV show watching option. In addition, $30 million a month using the Web visiting option. $32 million a month using the QVC Network option. $32 million a month by using the infomercial option and $64 million a month using the movie going option. That becomes a total of roughly $190 million a month profit for Comcast Corporation after honoring the half off cable TV discount. The minimum amount for the half off cable discount had already been met with just the required regular commercial watching alone.

Each of the above options varies in use. All can be custom tailored for particular marketing and promotions. That is part of why FIG. 1 step 6 important to creating a cable discount and making it viable for Comcast Corporation at the same time.

FIG. 1 step 7 states, “Factor in the number of advertisements, marketing, and promotions utilized”.

What must be factored in is the number of advertisements, marketing and promotion people are willing to put up with for free or discounted cable TV. With to many requirements, subscribers will get frustrated and burnt out. With to little, Comcast will have a tough time turning a profit or even honoring the promotion.

For the sake of this example, let's say Comcast has decided to limit the number of required commercials to 16, 30 second ads per day. That is, 16 ads at $500k each per day for a month. That is $240 million per month.

That comes out to about at $10 dollar discount per subscriber hard math. The average cable bill is almost $75 a month. It seems like it doesn't work mathematically, but it does.

Remember, FIG. 1 step 3, “Factor in the number of non participants who are subscribers”. It states in part, “ . . . non participants who are subscribers”. This simply means that not everyone who is eligible to participate will do so. Things then equal out.

However, a company will still want to have sizable participation. Otherwise the model will collapse. The key is balance. The number of ads, marketing, and promotion must be balanced.

So, Comcast makes the offer for half off cable TV knowing not everyone will participate. If participation increases, they can increase the number of promotions and other marketing like a TV premiere marketing venture. Comcast could simply work out a deal with a TV network where their millions of subscribers would tune to a season premiere to boost ratings. The subscribers would tune in as part of their cable discount requirement.

They could even drop in a few infomercials, or restaurant visits. All of these and more, working together toward discounted or free cable TV and sizable profit.

Another alternative to multiply profits for Comcast would be to apply this business model to the other services they offer and to do so separately. In other words, apply this method to their phone service, hi speed internet service, and cable separately.

Instead of being just 16 ads a day for the cable TV discount, they could add 8 more a day for phone service and an additional 8 per day for internet service. That is, 32 ads a day when originally there was only 16. The number of ads per customer increases. More ads mean more profit and a greater discount.

Because the phone and internet service is much cheaper than the average cable bill, it increases profit even more. The cost of the ad time is based on the number of subscribers and participants not the cost of item or service.

FIG. 1 step 8 states, “Sell advertising time based on the upfront number of subscribers and the market value for television advertising”.

At currant market rate at the time of this application, 24 million viewers would be about $500,000 per 30 second ad. Since Comcast has 24 million potential ad viewers in having 24 million subscribers, that can be sold as ad time. That is, $500,000 per 30 second ad using this business model.

Using FIG. 1 step 9, states “Offer and provide reprieve for participants who participate but fall short of requirements”.

Comcast as the applicable pay TV provider would offer reprieve for participants whom watch most of the required commercials but fell short of achieving the discounted or free cable. They could offer something like a one week complimentary HBO subscription or some sort of merchandise for trying. Enough so the participant doesn't get discouraged the next time around. Bottom line, Comcast turns a profit and the subscribers remain motivated and happy.

FIG. 1 step 10 states, “Participants take part in the applicable advertisement, marketing, and promotion”. This is when participants actually do what is required.

To get their discount, participants may have to watch 240 commercials a month. Visit several restaurants and websites and watch maybe four infomercials. Either way, they must participate to get the discount. That is the key.

FIG. 1 step 11 states, “Award applicable discount”. In this Comcast Corporation example, it would be discounted cable TV and possibly phone and internet service discounts as well.

Comcast Corporation gets their profit, subscribers get their discounted cable and more, and advertisers get the level of viewership they are paid for.

FIG. 1 steps 3, 4, 5, 6, 7, 8 and 9 may vary in order and yet still work.

The methods in flowcharts FIG. 2 simply holds participants accountable for the commercial advertisements and content they claimed to have watched. It is necessary to prevent reliance on an honor system.

As it is covered in FIG. 2 step 12, participants basically watch each of the required commercials as they play out in hopes of obtaining free or discounted cable.

As covered in the FIG. 2 method flowchart in steps 13, 14 and 15, the participants must response to a signal within a required commercial.

They must do so near the beginning as stated in FIG. 2 step 13. Near the middle as stated in FIG. 2 step 14, and near the end as stated in FIG. 2 step 15 of the commercial using a multimedia device.

For one example, Comcast participants would see a dot appear on the screen in the first few seconds of a commercial and respond to it using a multimedia device. Then near the middle of the commercial they would see another dot on the screen and respond. Lastly, another dot would appear toward the end of the commercial. The participant would then respond one last time for that particular ad. This supports the fact that they watched the entire ad without Comcast having to take the participants word for it.

FIG. 2 step 16 is where actual participation is confirmed.

Using the basic method in FIG. 1 flowchart in tandem with FIG. 2 flowchart for viewership accountability, Comcast would be able to provide half off average cable bills. This is at the currant market for a 30 second commercial, 24 million subscribers and an average $75 cable bill. The amount of profit and discounts may vary depending on the varying use of FIG. 1.

For cable to be free for subscribers, additional marketing, and promotions ventures would have to be utilized using the method in this application. Adding a reasonable amount of additional commercials to be viewed will also increase revenue.

### Advantages

From the description above, a number of advantages of some embodiments of this advertising, marketing, and promotions business model become evident:
(a) It makes pay TV and premium channels more affordable for everyone who participates fully.
(b) It can be extremely profitable in the billions of dollars for a pay TV provider.
(c) Discounts using this method can be applied to other items and services.
(d) It can be used by web TV providers enabling them to afford more content.
(e) Because of the method in FIG. 2, pay TV providers can prove to advertisers that their commercials were actually watched.
(f) Local, national, international, and regional commercials can be used when applying this business model.
(g) There can be multiple participants concurrently per household increasing the number of viewers that can be reached by advertisers.
(h) It is relatively easy to implement when weighed against the potential profit for the pay TV provider or other users.
(i) Someone elderly can have someone young participate on their behalf and it will still work.

### CONCLUSIONS, RAMIFICATIONS, AND SCOPE

Accordingly the reader will see that, according to one embodiment, I have provided for this advertising, marketing, and promotions business model, it can be applied to any provider type. That is from APPLE TV, AMAZON TV, HULU, NETFLIX, GOOGLE TV, YAHOO TV streaming service, SONY TV steaming service, or any cable, satellite pay TV, pay TV, or web TV service.

It also can be applied to create discounts for subway fairs, magazines subscriptions, mobile phone service, postal discounts, and more. Basically any situation where there is a product, item or service and multiple users and buyers. In many of these situations the item and or service can be made totally free for participants. All while, potentially turning a profit for the applicable companies using the business model in this application.

The following are some additional advantages:
because of the way it is made, the number of commercial spots and reels are not limited to the time within a TV show; because it uses the internet as well as video on demand, there is virtually unlimited space for all sorts and lengths of commercial advertising;
as advertisers pay for their spots, they can place secondary ads for a fraction of the cost; by secondary ads I mean ads for the same product in a different language giving the viewer a choice; this brings in extra cash for a particular company that would have otherwise not existed unlike traditional TV;
the above advantage was specific to language; the same concept applies to gender, culture, age groups, race, and even religion; viewers have the choice of their custom ad in their language, characteristic or lifestyle; the user can charge the normal fee for the main ad and for the secondary ads you charge a fraction of the cost; those fractions add up, this is something that is impossible with traditional television advertising;
some 24 million of Comcast Corporation subscribers for example, watching the commercials using my model is like having a mega hit TV show with 24 million viewers; the strip of commercials is the show; the show is commercials;
TV providers don't have to reinvest in more content to sell advertising time; that saves multi-millions of dollars; the ads are viewed because of the incentive offered; there is no need for a show;
commercials can be seen full screen, not buried in graphics; imagine going to the movies and the movie is surrounded by heavy graphics; many times when ads are online they are surrounded by other advertisements and other graphics and information while they are playing out; full screen is a better option to get the most out of a commercial or advertisement; it is possible with my method;
because of the discount created when using this method, people will be able to afford more channels, high speed internet and phone service increasing the revenues and the viability of the networks carried for content providers;
because companies can offer free items, services and substantial discounts, they can increase their customer subscriber base, and more subscribers means more revenue; companies can expand their territory even in a bad economy;
subscribers and participants can view ad spots at their leisure, 24 hours 7 days a week throughout the month thanks to on demand service, the internet and other media and multimedia devices and services;
because the ads can be watched on demand and or on web TV, every subscriber participant who doesn't have on demand service can also participate;
web traffic will be so substantial to view commercial reels on the web, web ads can be placed on the website leading up to the required commercial viewing;
it is highly profitable in the billions when there are a proper number of participants and this model is executed properly; this helps to rebalance the traditional pay TV business model that is slowly becoming obsolete; this is achieved by replenishing lost revenue for Pay TV providers, content producers and TV networks; this keeps the traditional TV models viable;
this method offers reprieve to those who participate; whomever falls short of whatever is required for discounted and or free item or service can still get a reward of some sort encouraging them to try again;
it is relatively inexpensive to execute and maintain;
using the method in FIG. 2, companies can guarantee certain advertisements where actually watched instead of depending on an honor system;
although effective when partnering with existing pay TV providers and other businesses; it also works as a stand alone business model as long as there are a substantial group of participants;
it resuscitates TV's traditional advertising business; because of the many advances in computer technology and the internet, many have seen a threat to the traditional TV advertising business model we have gotten used to; web TV is just beginning to replace traditional cable and satellite TV; it's similar to what happened to the music and publishing industry in relation to the internet and technology; this invention returns content providers back to viability, saving jobs and preserving the media industry.

While the above description contains several specificities, these should not be construed as limitations on the scope of any embodiment, but as exemplifications of the presently preferred embodiments thereof. Many other ramifications and variations are possible within the teachings of the various embodiments. For example, it also works with non profits. Thus the scope of the invention should be determined by the appended claims and their legal equivalents, and not by the examples given.

I claim:

1. A method for creating and awarding discounts for media and multimedia services, and other items and services using a multimedia device, comprising:
(a) factor in the number of non participants who are subscribers,
(b) factor in the number of potential participants who are subscriber participants,
(c) factor in the cost of applicable item and service being discounted,
(d) factor in what is used for advertisement, marketing, and promotion meaning what must be viewed, used, and experienced to get the applicable discount, free item, and service,
(e) factor in the number of advertisements, marketing, and promotions utilized,
(f) sell advertising time based on upfront number of subscribers and the market value for television advertising, as if the number of subscribers and participants are the viewing audience and then sell ad time based on that number,
(g) offer and provide reprieve for participants who participate but fall short of requirements for any applicable discount, free items, and services,
(h) participants must view applicable commercials and content on a media platform and take part in applicable marketing and promotions,
(i) participant qualifies for and receives applicable discount, free item, and service,
whereby discount is created and received.

2. A method for confirming applicable commercial advertisements and content are watched in their entirety using a multimedia device, comprising:
(a) applicable media content is played out using applicable media and multimedia device,
(b) participants respond to signal near the beginning, middle, and end of applicable content,
(c) after participation, confirm viewership of all required advertisements and content,
whereby participation is official.
